(19) United States
(12) Patent Application Publication
(10) Pub. No.: US 2018/0094966 A1
(43) Pub. Date: Apr. 5, 2018

(54) GENERATING LOAD CHARACTERISTIC INFORMATION BASED ON SENSOR DATA

(71) Applicant: Amazon Technologies, Inc., Reno, NV (US)

(72) Inventor: John Nicholas Buether, Seattle, WA (US)

(73) Assignee: Amazon Technologies, Inc., Reno, NV (US)

(21) Appl. No.: 14/196,745

(22) Filed: Mar. 4, 2014

(51) Int. Cl. G01G 19/12

(52) U.S. Cl. CPC G01G 19/12

(57) ABSTRACT

A variety of types of sensors may be placed in or on an interior or exterior surface of a vehicle. The sensors may capture various kinds of data such as time-of-flight data, weight data, image data, and so forth. The sensor data may be transmitted via one or more network connections to a device configured to process the sensor data to generate load characteristic information. The load characteristic information may be indicative of one or more characteristics of a vehicle load of the vehicle such as a space utilization characteristic.

### BACKGROUND

A vast amount of freight is transported daily using a variety of modes of transportation including, for example, ships, aircraft, trains, trucks, and so forth. Certain conventional methods for loading freight on a vehicle may result in under-utilization or inefficient utilization of available space due to, among other things, poor visibility of interior spaces as additional freight is loaded. The under-utilization or inefficient utilization of available interior space may require additional trips or vehicles for transporting a given amount of freight, thereby increasing transport costs and reducing the efficiency or timeliness with which the freight is transported to its ultimate destination. In addition, certain conventional methods for loading or un-loading freight onto or from a vehicle may not allow for adjustment to the weight distribution of freight or other techniques for ensuring that partial loads are transported in a manner that ensures the integrity of the freight contents.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic diagram of an illustrative use case in which one or more sensors are employed to gather and transmit sensor data for use in generating load characteristic information in accordance with one or more example embodiments of the disclosure.

FIG. 2 is a schematic block diagram of an illustrative system architecture that, among other things, enables the receipt and processing of sensor data to generate load characteristic information in accordance with one or more example embodiments of the disclosure.

FIG. 3 is a data flow diagram that illustrates use of load characteristic information generated based on sensor data to alter one or more characteristics of a load in accordance with one or more embodiments of the disclosure.

FIGS. 4A-4C are schematic diagrams illustrating various sensor arrangements in accordance with one or more example embodiments of the disclosure.

FIG. 5 is a process flow diagram of an illustrative method for processing sensor data to generate load characteristic information in accordance with one or more example embodiments of the disclosure.

FIG. 6 is a process flow diagram of an illustrative method for rendering a representation of load characteristic information and generating one or more modified representations of the load characteristic information based on user input in accordance with one or more embodiments of the disclosure.

FIG. 7 is a process flow diagram of an illustrative method for executing automated decision-making processing to cause one or more desired load characteristics to be achieved in accordance with one or more embodiments of the disclosure.

FIG. 8 is a process flow diagram of an illustrative method for modifying one or more characteristics of a planned load based on load characteristic information generated from sensor data in accordance with one or more embodiments of the disclosure.

### DETAILED DESCRIPTION

### Overview

This disclosure relates to, among other things, systems, methods, and computer-readable media for generating load characteristic information based on sensor data. This disclosure also relates to, among other things, systems, methods, and computer-readable media for utilizing load data, route data, and/or load characteristic information generated based on sensor data to modify one or more characteristics of a load.

As used herein, the term “load” may refer to freight that has already been loaded into a particular environment, freight that is in the process of being loaded, freight that has not yet been loaded but has been designated for loading, freight that will be loaded at some future point in time, or the like. Thus, the term “load” may at times refer to an existing load (e.g., freight that has already been loaded into a particular environment), a planned load (e.g., a load that is in-progress and which may include an existing load and/or additional freight that has not yet been loaded but is planned for loading), an expected load, a desired load, and so forth. Accordingly, it should be appreciated that example embodiments described in connection with a particular type of load are also applicable to any other type of load.

In addition, as used herein, the term “load data” may refer to any data that identifies one or more characteristics of a freight or cargo load such as, for example, respective weights of one or more containers or packages, cumulative weight, dimensions, contents, and so forth. As used herein, the term “load characteristic information” may refer to information that identifies one or more characteristics of a load and which is derived from data captured by one or more sensors. Load characteristic information may include, but is not limited to, spatial distribution information indicative of how a load is physically distributed within a particular space, vibration or movement-related information indicative of vibrational or movement characteristics of a load, weight distribution information indicative of how weight is distributed between various portions of a load, and so forth. In addition, as used herein, the term “route data” may refer to any data that identifies one or more delivery parameters associated with one or more transportation routes such as, for example, origin and destination points, delivery schedules, and so forth.

While example embodiments of the disclosure may be described in the context of freight that is loaded onto a mobile vehicle for transport from one or more points of origin to one or more destination points, it should be appreciated that the disclosure is not limited to such scenarios. That is, embodiments of the disclosure may be applicable to any scenario in which data gathered by sensors is processed to generate information indicative of how items are organized within a given volume of space including, but not limited to, space utilization information indicative of the manner in which or extent to which a volume of space is occupied or un-used, weight distribution information indicative of a weight distribution of items in a given volume of space, and so forth. Accordingly, while the terms “freight,” “cargo,” “load,” or the like may at times be used interchangeably herein to describe items that are loaded into a vehicle for transport, such terms are also intended to cover items housed in a non-mobile environment such as inventory housed in a warehouse or the like.

In an example embodiment of the disclosure, freight may be loaded into a vehicle such as the trailer of a truck. In certain example embodiments, the freight may include packages or containers that are loaded into an interior loading space of the vehicle. In other example embodiments, the freight may be loaded into shipping containers that may, in turn, be loaded onto the vehicle. As such, depending on the particular scenario, load characteristic information may describe, and may be used to analyze, various characteristics of a load as it is placed in the interior space of a transport vehicle or the interior space of a container designated for transport via a transport vehicle. The freight may be loaded at a particular point of origin such as a warehouse location and may be designated for delivery to one or more destination points. As is typically the case, the freight may be loaded into the vehicle incrementally, and in some scenarios may be loaded from multiple points of origin.

The process of loading freight into a vehicle often results in the under-utilization or inefficient utilization of interior vehicle space. For example, as freight is loaded into the trailer of a truck, the freight may be organized in such a manner so as to leave certain spaces unoccupied. Additional freight loaded into the truck may reduce visibility of these unoccupied spaces, or in some cases may effectively create a barrier to reaching such spaces, thereby resulting in under-utilization or inefficient utilization of the entire volume of interior space available for loading. In addition, freight may include containers, packages, or the like of numerous different sizes, dimensions, and weights, and determining an organization or makeup of the freight that most efficiently utilizes an available volume of space may be difficult. For example, conventional processes for loading freight onto a vehicle may result in a scenario in which relatively heavy freight is loaded on the vehicle in a manner that generates a relatively large amount of unoccupied space. In such a scenario, conventional freight loading processes may be unable to identify that additional freight that is lighter but which has larger dimensions may be loaded onto the vehicle to more efficiently utilize the under-occupied space while ensuring that any applicable freight weight limits are not exceeded.

In addition, in many instances, the relative weight distribution of freight or the contents thereof may not be known. Although indicia may be applied to containers or packages that identify the relative fragility of their contents, organizing the freight in a manner that reduces the likelihood of damage to freight contents may be a difficult task. For example, the order in which freight is loaded into a vehicle, the diminished visibility of interior space as additional freight is loaded, and the lack of knowledge regarding the relative weight distribution of the freight, among other factors, may make it difficult to organize the freight in a manner that is most efficient for maintaining the integrity of the freight contents.

Moreover, the vibrational or motion characteristics of a load during transport may be difficult to ascertain. For example, certain containers or packages may be more susceptible to increased vibration or movement during transport due to various factors such as the how the freight is organized within the vehicle, characteristics of the containers or packages themselves or the contents thereof, or the like.

Example embodiments of the disclosure employ sensors for gathering data that can be processed to generate load characteristic information indicative of one or more characteristics of a freight load. The load characteristic information may be used to identify under-utilized interior space, a weight distribution of a load, vibrational or movement characteristics of a load, or the like. One or more characteristics of a freight load or the manner in which the freight is loaded may then be altered based on an analysis of the load characteristic information. For example, an organization of an existing load, a planned organization or protocol for adding additional freight to an existing load, or aspects of a planned future load may be modified to make more effective use of under-utilized space, to alter the weight distribution of the load, to provide greater protection for the contents of the load, to reduce vibration or movement of the load during transport, and so forth.

In example embodiments of the disclosure, one or more sensors may be provided to gather data relating to the interior space of a vehicle into which freight may be loaded. Continuing with the illustrative example from above, sensors may be provided to gather data relating to the interior of a truck such as the interior of a truck trailer. The sensors may be positioned on or embedded in an interior surface of the truck such as the floor, ceiling, or walls. The sensors may be arranged in accordance with any suitable configuration such as, for example, in an array, a grid-like arrangement, a linear arrangement, or the like. In certain example embodiments, sensors may be positioned on or in the load itself in lieu or in addition to placement of the sensors in the truck.

Any of a variety of types of sensors may be employed. For example, time-of-flight sensors may be employed to measure distance to an object based on the time required for an emitted pulse of electromagnetic radiation or a sound pulse to be reflected back. Such time-of-flight sensors may utilize any of a variety of sensing technologies such as LIDAR, Radio Detection and Ranging (RADAR), Sound Navigation and Ranging (SONAR), or the like. As an illustrative example, time-of-flight sensors may be positioned in or on the floor of the interior of a truck, and data gathered by the sensors may be used to identify available floor space. Similarly, time-of-flight sensors may be positioned in or on the ceiling of the interior of a truck, and data gathered by the sensors may be used to identify various heights to which freight load has been stacked. As yet another example, time-of-flight sensors may be positioned in or on the walls of the interior of a truck to identify free spaces along the length or width of the truck interior.

Alternatively, or additionally, photodetectors such as photodiodes may be used to measure the intensity of reflected light by converting the light to a current or voltage. For example, photodiodes may be positioned in or on the floor, ceiling, or walls of the interior of a truck, and data gathered by the photodiode sensors may be used to determine space utilization throughout the interior of the truck.

A variety of other types of sensors may be utilized as well to measure any of a variety of other types of parameters associated with reflected electromagnetic radiation such as a frequency spectrum, an angle, a frequency shift, a frequency value, polarization, and so forth. In addition, any of a variety of seismic sensors may be employed to gather data indicative of a weight distribution of a load, how tightly a load is packed, how well a load is secured, or the like. Weight sensors may also be employed to gather weight distribution data. Still further, image sensors may be employed to gather image data. For example, cameras or other image sensors may be used to gather image data which may be displayed to an end user and/or processed—potentially in conjunction with other sensor data—to generate load characteristic information.

The data gathered by the sensors may be transmitted via a broadcast device to a load characteristic information (LCI) presentation device. The LCI presentation device may be a user device such as a laptop computer, desktop computer, tablet computer, a wearable computing device, or the like. The LCI presentation device may be an in-vehicle device or a device capable of being used independently from the vehicle. The sensor data may be transmitted via wired or wireless communication links between the sensors and the broadcast device. For example, the broadcast device may be configured to receive aggregated sensor data from one or more sensors via one or more wired or wireless communication links. The broadcast device may be located within the vehicle or may be provided external to the vehicle such as, for example, in a loading dock area. The broadcast device may be configured to transmit the aggregated sensor data via a wired or wireless connection to the LCI presentation device.

In those example embodiments in which the sensor data is transmitted over one or more wireless networks, any suitable wireless network having any suitable configuration may be employed for transmission of the sensor data from the sensors to the broadcast device and/or for routing of the sensor data from the broadcast device to the LCI presentation device. Such wireless networks may include, but are not limited to, a wireless local area network (WLAN), a personal area network (PAN), a wireless mesh network, and so forth. In addition, any suitable wireless communication protocol, technology, or standard may be employed including, but not limited to, a radio frequency communication protocol such as any of the Institute of Electrical and Electronics Engineers' 802.11 standards (e.g., Wi-Fi™), Near Field Communication (NFC) standards, or the like; a microwave communication protocol such as Bluetooth™; and so forth.

In certain example embodiments, the LCI presentation device may be configured to receive the sensor data as input and process the data to generate load characteristic information. More specifically, the LCI presentation device may store computer-executable instructions that when executed by one or more processors cause one or more algorithms to be executed for generating the load characteristic information. As previously noted, the load characteristic information may include space utilization information that identifies occupied and available space along the height, length, or width of an interior of the vehicle, weight distribution information, seismic information indicative of vibrational or motion characteristics of a load, and so forth.

The LCI presentation device may include a display and one or more applications (e.g., a graphical user interface (GUI)) for presenting the load characteristic information to a user via the display. The load characteristic information may be presented in any suitable format including, but not limited to, text, audio, video, or graphical format. As an illustrative example, a graphical representation of the interior of a truck that depicts how a freight load is organized or a planned organization of a load may be generated from the load characteristic information and presented to a user. A capability to manipulate the graphical representation may be provided such that the user may experiment with various hypothetical load configurations and makeups in an effort to more effectively utilize unoccupied space. A dynamic representation of the load configuration or makeup over time (e.g., during transit, during loading, etc.) may also be presented to the user. This dynamic representation may allow the user to determine how the initial load configuration, vibrational or movement characteristics of the load, and so forth may have changed over time.

In certain example embodiments, the broadcast device and/or the LCI presentation device may be configured to transmit the sensor data to one or more remote servers via one or more wireless communication links that may form part of any of the types of wireless networks and employ any of the wireless communication standards noted above. In certain example embodiments, the processing to generate the load characteristic information from the sensor data may be performed by the remote server in addition to being performed by the LCI presentation device, while in other embodiments, the processing may be performed by the remote server in lieu of being performed by the LCI presentation device. Thus, in certain example embodiments, rather than being processed on the LCI presentation device, the sensor data may be processed on a remote server and may be received from the remote server for rendering to a user on the LCI device.

Based on a review of the load characteristic information, a user may choose to alter one or more characteristics of an existing or planned load. For example, a user may choose to alter a configuration or makeup of a load to make more effective use of under-utilized space, to reduce vibration or movement of the load during transport, to alter a weight distribution of the load to provide more protection for the contents of the load, and so forth. In certain example embodiments, the remote server(s) may receive sensor data associated with different loads across, for example, a fleet of vehicles. The remote server(s) may transmit the load characteristic information associated with the fleet of vehicles to LCI presentation devices for presentation to one or more users. In this manner, it may be determined whether there is an opportunity to shift load between vehicles in a fleet.

Additionally, in certain example embodiments, various recommendations may be generated and presented to a user along with the load characteristic information. For example, a remote server and/or an LCI presentation device may generate recommendations for alternative load configurations based on the load characteristic information. Further, in certain example embodiments, a remote server may utilize route data in addition to the load characteristic information in order to generate any of a variety of types of recommendations such as, for example, recommendations to alter delivery routes to reduce vibration or movement of a load during transport, recommendations to shift existing load between vehicles in a fleet or alter the configuration or makeup of planned loads for vehicles in a fleet in order to make more effective use of unoccupied space or reduce vibration or movement, or the like. In certain example embodiments, the load characteristic information may be based at least in part on sensor data gathered during transport of a load, and may be analyzed to determine how the configuration of future planned loads can be improved to more effectively utilize interior space, reduce vibration and movement of the load during transport or modify weight distribution to better secure a load or lessen the likelihood of damage to load contents, and so forth.

In certain example embodiments, the load characteristic information generated from sensor data may be provided to an automated decision-making system that may be configured to manage or control freight loading operations. For example, load characteristic information generated by a remote server may be transmitted to an automated decision-making system. The automated decision-making system may be configured to perform algorithmic processing based on the received load characteristic information and control or modify freight loading operations based on the results of such processing.

For example, based on the load characteristic information, the decision-making system may generate an instruction indicative of a desired configuration or makeup of an existing or planned load and/or the an instruction indicative of a desired order in which packages or containers of the freight are to be loaded, and may communicate the instruction to an end user or another automated system capable of implementing the instruction. As another non-limiting example, the automated decision-making system may determine that a total weight threshold for a freight load has been met or that a space utilization threshold has been met, and may transmit an instruction to another system (e.g., a conveyor belt system) to halt the loading of additional freight. In yet another non-limiting example, the automated decision-making system may determine that an existing freight load or a planned load fails to meet a space utilization threshold, a total weight threshold, a weight distribution threshold, a vibrational or movement-related threshold, or the like, and may instruct an end user or another system to modify the configuration or makeup of the load, or the manner in which freight is loaded, in order to meet an applicable threshold. It should be appreciated that the automated decision-making system may be provided at a loading site or at one or more remote locations. It should further be appreciated that the automated decision-making system may include any suitable combination of hardware (e.g., servers, networking devices, etc.) and software.

In addition, in certain example embodiments, load data may be utilized in conjunction with sensor data to generate the load characteristic information. The load data for any particular container may include, for example, a weight of the container, an identification of its contents, a time/datestamp indicative of when the container was loaded into the vehicle, dimensions of the container, or the like. At least a portion of the load data may be stored in, for example, a radio frequency identification (RFID) tag attached to or embedded in the container such that the load data may be read by an RFID reader. Alternatively, or additionally, the load data may be captured by a device prior to placement of the load in a vehicle. The load data capturing device may be provided independent of the vehicle or may be integrated with or otherwise associated with a particular vehicle. The load data in combination with the sensor data may be used, for example, to identify a precise current or planned location of a particular container within the interior space of a vehicle. Such information may then be used to determine whether movement or placement of that container in a new location within the truck would improve space utilization, reduce vibration or movement during transport, diminish the likelihood of damage to the contents of the container, or the like.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Use Cases and System Architecture

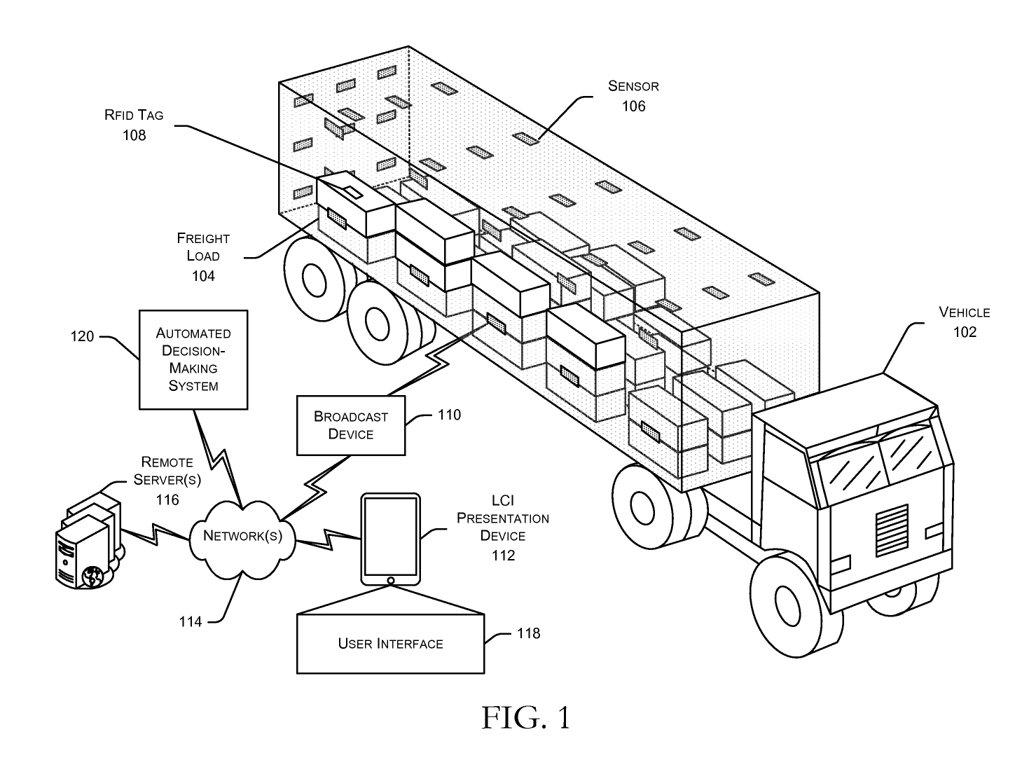

FIG. 1 is a schematic diagram of an illustrative use case in which one or more sensors are employed to gather and transmit sensor data for use in generating load characteristic information in accordance with one or more example embodiments of the disclosure.

Referring to FIG. 1, a vehicle 102 is illustratively depicted. Although the vehicle 102 is depicted as a truck and example embodiments of the disclosure may be described in the context of freight loaded into the interior space of a truck, it should be appreciated, as noted above, that embodiments of the disclosure are equally applicable to any type of vehicle capable of transporting freight (e.g., aircraft, trucks, boats, ships, vans, cars, trains, etc.), or to any suitable non-mobile environment or structure capable of housing packages, containers, or the like such as, for example, the interior of a building (e.g., a warehouse).

A freight load 104 is illustratively depicted as having been loaded into the interior space of the vehicle 102. Although the freight load 104 is depicted as including containers or packages of equal dimensions, it should be appreciated that the freight load 104 may, in various example embodiments, include load having numerous different dimensions, sizes, weights, contents, etc. Further, it should be appreciated that the freight load 104 depicted in FIG. 1 may correspond to a load in various states such as, for example, a complete load ready for transport, an incomplete load to which additional load will be added, a load in transit, or the like. In addition, the freight load 104 may be a planned load that has not yet been loaded into the vehicle 102.

One or more sensors 106 may be provided to gather data relating to the interior space of the vehicle 102. The sensor(s) 106 may be affixed to, embedded in, or otherwise integrated or associated with the vehicle 102. More particularly, in certain example embodiments, the sensor(s) 106 may be provided in or on interior surfaces of the vehicle 102 such as, for example, in or on an interior ceiling, floor, or walls of the vehicle 102. While the sensors 106 are depicted in FIG. 1 as being provided in an array or grid-like configuration, it should be appreciated that the sensors 106 may be arranged according to any suitable configuration such as a linear configuration, a random distribution, etc., with each sensor 106 being configured to generate sensor data relating to a particular portion of the volume of interior space. Although not depicted in FIG. 1, in certain example embodiments, sensors may be embedded in or affixed to any portion of the freight load 104 (e.g., embedded in or affixed to a particular container) in lieu of or in addition to placement in the vehicle 102.

The sensors 106 may include any of a variety of different types of sensors. For example, the sensors 106 may include time-of-flight sensors configured to measure distance to an object based on the travel time of an emitted pulse of electromagnetic radiation or an emitted pulse of sound that is reflected back. Time-of-flight sensors may also be configured to measure other parameters such as velocity by measuring the difference in receipt times of reflected pulses of electromagnetic radiation or a frequency shift associated with reflected pulses of sound. As an illustrative example, time-of-flight sensors positioned in or on the floor of the interior of the vehicle 102 may generate data indicative of whether any portion of the load 104 is occupying particular portions of the floor, thereby providing an indication of the location(s) and amount of available floor space. Similarly, time-of-flight sensors positioned in or on the ceiling of the interior of the vehicle 102 may generate data indicative of the heights to which various portions of the freight load 104 have been stacked, thereby providing an indication of the location(s) and amount of available vertical space. As yet another example, time-of-flight sensors may be positioned in or on the walls of the interior of a vehicle 102 to identify available space along the length or width of the vehicle interior.

The time-of-flight sensors may utilize any of a variety of sensing technologies such as LIDAR, RADAR, SONAR, or the like. Depending on various characteristics of the freight load 104, certain sensing technologies may generate more accurate data than other technologies. For example, if the freight load 104 includes mostly cardboard containers or packages, LIDAR may generate more accurate data than RADAR because the radio waves utilized in RADAR may be more prone to absorption or scatter by cardboard.

Alternatively, or additionally, the sensors 106 may include photodetectors such as photodiodes that may be configured to measure the intensity of reflected light by converting the light to a current or voltage and measuring the current or voltage. For example, photodiodes may be positioned in or on the floor, ceiling, or walls of the interior of the vehicle 102, and data gathered by the photodiode sensors may be used to determine the amount and location of available space throughout the interior of the vehicle 102.

Further, the sensors 106 may include any of a variety of other types of sensors configured to measure any of a variety of other types of parameters associated with reflected electromagnetic radiation such as a frequency spectrum, an angle, a frequency shift, a frequency value, polarization, and so forth. As an illustrative example, an interior surface of the vehicle 102 (e.g., an interior wall, floor, or ceiling), a package, a container, or the like may be painted or textured so as to generate a signature frequency spectrum for electromagnetic radiation (e.g., visible light) reflected from the painted or textured surface. For example, a surface that is painted a particular color will reflect light having a frequency spectrum that indicates a peak at a particular frequency corresponding to that color. Sensors configured to gather this frequency spectrum data may be provided, and the frequency spectrum data may be processed to correlate the data to a particular interior surface of the vehicle 102. In this manner, it may be determined whether a portion of the freight load 104 occupies a given interior space. Further, frequency spectrum data may be used to enhance the processing of image data to generate load characteristic information having greater informational potential.

As another illustrative example, the sensors 106 may include one or more sensors configured to generate light of different polarizations and measure characteristics of the reflected polarized light. Certain types of packaging material (e.g., certain types of cardboard) reflect different polarizations of light differently. Accordingly, sensors configured to gather light polarization data may be employed, and the data may be analyzed to supplement or refine information derived from other types of sensor data. For example, the light polarization sensor data may be analyzed to distinguish, for example, between a cardboard container and an interior surface of the vehicle 104 that may be painted brown in those instances in which such a distinction may not be capable of being made based on frequency spectrum data alone.

In addition, the sensors 106 may include any of a variety of seismic sensors configured to gather data indicative of vibrational characteristics of the freight load 104, movement of the freight load 104, a weight distribution of the freight load 104, a packing density of the freight load 104, the extent to which the freight load 104 is secured, or the like. In certain example embodiments, the vehicle 102 may be subjected to vibrational forces by, for example, shaking, striking, or vibrating portions of the vehicle 102. Sensor data gathered by seismic sensors may then be processed and analyzed to determine how the freight load 104 responds to such vibrational forces. Seismic sensor data may be gathered in a test environment (e.g., prior to transport) to allow for processing and analysis of the data and potential modification of the load configuration prior to transport. In other example embodiments, seismic sensor data gathered during transport may be processed and analyzed to determine how natural forces to which the vehicle 102 is subjected during transport along a particular route affect the vibrational and movement characteristics of the freight load 104. This in-transport seismic sensor data may be used to modify load configurations of future loads, delivery routes, or the like. In addition, seismic sensor data gathered during transport may be processed in real-time to generate load characteristic information that may be presented to a vehicle operator in real-time, thereby providing the vehicle operator with an opportunity to modify driving characteristics, a configuration of the load 104 during transit, or the like so as to lessen vibration or movement of the load 104 during transport.

In addition, in various example embodiments of the disclosure, data gathered by seismic sensors may be used in a variety of other ways. For example, seismic sensor data may be used to generate a pricing structure for items where more fragile items that are more susceptible to damage or loss due to vibration or movement are priced differently from less fragile items. A pricing structure based on seismic sensor data may reduce the time and costs associated with item inspection. In addition, in various example embodiments of the disclosure, seismic sensor data may be used to track customer concessions due to damage or loss of items.

The seismic sensors may be positioned in or on an interior surface of the vehicle 102 (e.g., embedded in an interior floor of the vehicle 102) or may be positioned in or on an exterior surface of the vehicle 102. Embedding sensors in an interior surface of the vehicle 102 or affixing or embedding sensors to an exterior surface of the vehicle 102 may minimize the potential for damage to the sensors. Still further, the sensors 106 may include weight sensors for gathering weight distribution data, image sensors, and so forth.

It should be appreciated that the above description of types of sensors 106 that may be employed and the types of parameters that such sensors may gather sensor data with respect to are merely illustrative and not exhaustive. Any suitable type of sensor may be employed to generate data with respect to any suitable parameter, where such sensor data may be used to generate load characteristic information indicative of one or more characteristics of an existing load, a planned load, or a future load. In addition, certain devices may be employed as sensors despite having a different primary function. For example, a wireless networking device, a gimbaled scanning device, and so forth may be used to gather data such as image data that may be processed to generate load characteristic information.

In certain example embodiments, various types of load data relating to the freight load 104 may be available. Load data for a particular container or package included in the freight load 104 may include, for example, a weight of the item, an identification of its contents, a time/datestamp indicative of when the item was loaded into the vehicle, dimensions of the item, or the like. Load data relating to a particular item of the freight load 104 may be stored in, for example, a radio frequency identification (RFID) tag 108 attached to or embedded in the item, and the load data may be read from the RFID tag 108 by an RFID reader. It should be appreciated that the RFID tag 108 and the associated communication protocol is merely illustrative and that numerous other wireless data transfer technologies may be employed such as, for example, Bluetooth™, NFC, optical RFID, barcodes, IEEE's RuBEE™ wireless tag system, and so forth. In certain example embodiments, capturing load data (including weight data) via a wireless data transfer technology noted above (e.g., RFID) may render separate weight sensors unnecessary.

The data gathered by the sensors 106 may be transmitted to a broadcast device 110 via one or more wired or wireless communication links. Although the broadcast device 110 is depicted as being provided externally to the vehicle 102, it should be appreciated that the broadcast device 110 may alternatively be provided within the vehicle 102 (e.g., integrated with electronic circuitry of the vehicle 102 or otherwise associated specifically with the vehicle 102).

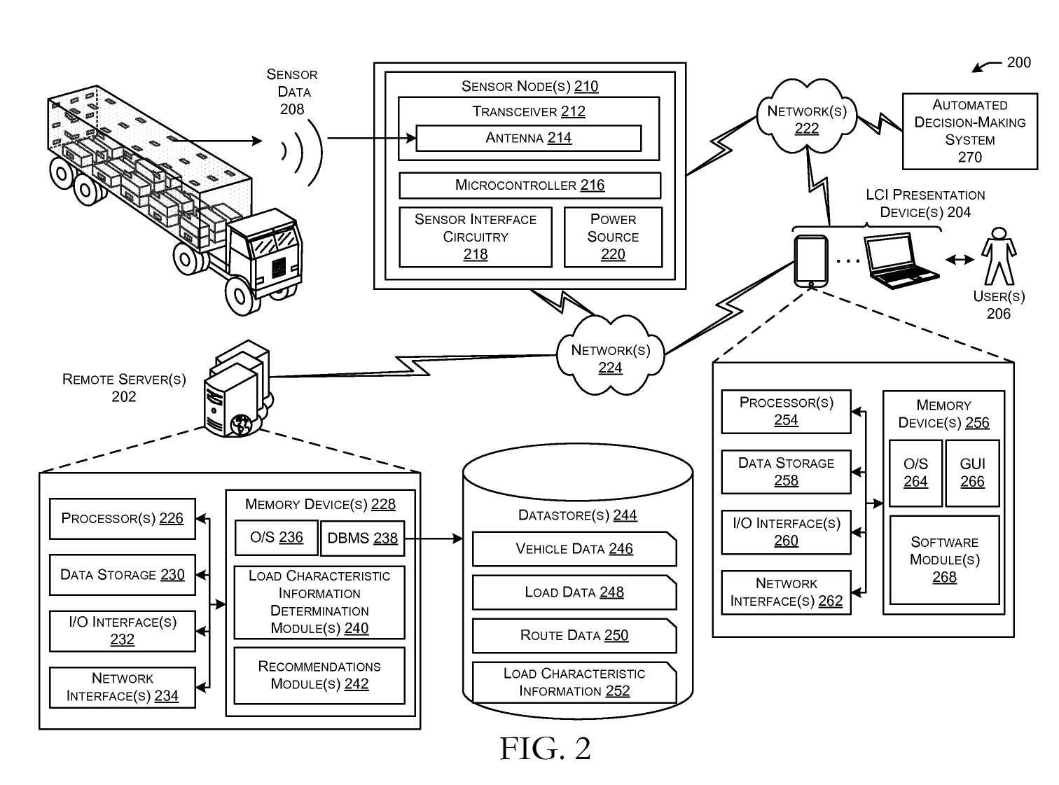

As will be described in more detail in reference to FIG. 2, the broadcast device 110 may be a wireless sensor node forming part of a wireless sensor network such as a wireless mesh network. A single broadcast device 110 may serve as a wireless node for all sensors 106 provided in the vehicle 102, or multiple broadcast devices 110 may be provided, each serving as a wireless network node for one or more sensors. The broadcast device 110 may include sensor interface circuitry for monitoring or controlling the sensors and an antenna for receipt of sensor signals. As previously noted, the sensors 106 may be configured to communicate with the broadcast device 110 using any suitable wired (e.g., Ethernet) or wireless communication technology. Although example embodiments of the disclosure are described herein in connection with a broadcast device 110 that includes an antenna for receiving sensor data, it should be appreciated that in certain example embodiments, the sensor data may be transmitted from the sensors 106 to the device 110 or another suitable device via one or more wired connections.

The broadcast device 110 may be configured to communicate sensor data received from the sensors 106 to the LCI presentation device 112 via a wired or wireless communication link forming part of one or more networks 114. The LCI presentation device 112 may be a user device such as laptop computing device, a desktop computing device, a tablet computing device, a smartphone with data capabilities, a wearable computing device, or the like. Although the LCI presentation device 112 is depicted as being provided independently of the vehicle 102, in certain example embodiments, the LCI presentation device 112 may be an in-vehicle device, potentially integrated with an existing in-vehicle infotainment (IVI) system or the like.

The network(s) 114 may include any suitable wired or wireless network having any suitable configuration for transmission of the sensor data from the broadcast device 110 to the LCI presentation device 112 including, but not limited to, a LAN (e.g., a WLAN), a PAN, and so forth. In addition, in those embodiments in which the network(s) 114 include one or more wireless networks, any suitable wireless communication protocol, technology, or standard may be employed including, but not limited to, a radio frequency communication protocol Wi-Fi™, NFC, or the like; a microwave communication protocol such as Bluetooth™; and so forth. Further, although not depicted in FIG. 1, it should be appreciated that sensor data may be transmitted from the sensors 106 to the broadcast device 110 via one or more communication links forming part of the network(s) 114.

In certain example embodiments, the LCI presentation device 112 may be configured to receive the sensor data as input and process the data to generate load characteristic information. As previously noted, the load characteristic information may include space utilization information that identifies occupied and available space along the height, length, or width of an interior of the vehicle 102, weight distribution information, seismic information indicative of vibrational or motion characteristics of the freight load 104, and so forth.

The LCI presentation device 112 may include a display and a user interface 118 (e.g., a graphical user interface (GUI)) for presenting the load characteristic information to a user via the display. The load characteristic information may be presented in any suitable format including, but not limited to, text, audio, video, or graphical format. As described earlier, the load characteristic information may include a graphical representation of the interior of the vehicle 102 that depicts a configuration and/or makeup of the freight load 104. A capability to manipulate the graphical representation may be provided such that the user may experiment with various hypothetical load configurations in an effort to more effectively utilize unoccupied space, alter weight distribution, modify vibrational or movement characteristics, and so forth. A dynamic representation of changes to the load configuration or makeup over time (e.g., during transit, during loading) may also be presented to the user. This dynamic representation may allow the user to observe changes to the load configuration or makeup over time, vibrational or movement characteristics of the load during transit, or the like.

In certain example embodiments, the broadcast device 110 and/or the LCI presentation device 112 may be configured to transmit the sensor data to one or more remote servers 116 via one or more wireless communication links that may form part of the network(s) 114. In certain embodiments, the processing to generate the load characteristic information from the sensor data may be performed by the remote server(s) 116 in addition to being performed by the LCI presentation device 112, while in other embodiments, the processing may be performed by the remote server(s) 116 in lieu of being performed by the LCI presentation device 112.

Based on a review of the load characteristic information, a user may choose to alter one or more characteristics of an existing load or a planned load. For example, a user may choose to alter a configuration and/or makeup of a load to make more effective use of under-utilized space, to reduce vibration or movement of the load during transport, to alter a weight distribution of the load to provide more protection for the contents of the load, and so forth. In certain example embodiments, the remote server(s) 116 may receive sensor data associated with different existing or planned loads across, for example, a fleet of vehicles. The remote server(s) may transmit the load characteristic information associated with the fleet of vehicles to the LCI presentation device 112, and potentially one or more other LCI presentation devices. In this manner, it may be determined whether there is an opportunity to shift existing load between vehicles in a fleet or alter the configuration or makeup of one or more planned loads.

Additionally, in certain example embodiments, various recommendations may be generated and presented to a user along with the load characteristic information. For example, the remote server(s) 116 and/or the LCI presentation device 112 may generate recommendations for alternative load configurations based on the load characteristic information. Further, in certain example embodiments, the remote server(s) 116 may utilize route data in addition to the load characteristic information in order to generate any of a variety of types of recommendations such as, for example, recommendations to alter delivery routes to reduce vibration or movement of a load during transport, recommendations to shift existing load between vehicles in a fleet or alter the configuration or makeup of planned load(s) across a fleet in order to make more effective use of unoccupied space, reduce vibration or movement of the load, or the like.

In addition, in various example embodiments, load data may be used in conjunction with sensor data to generate load characteristic information that identifies a precise location of a particular container within the interior space of a vehicle. The time/datestamp associated with the loading of a particular container of the load 104 into the vehicle 102 may be correlated with a change in the data sensed by a particular sensor (e.g., a time-of-flight sensor), and thus, a precise location of the container within the vehicle 102 may be determined. Such information may be used, for example, to determine whether movement of that container to a new location within the vehicle 102 or placement of that container within a location other than a planned location within the vehicle 102 would improve space utilization, reduce vibration or movement during transport, diminish the likelihood of damage to the contents of the container, or the like. As another non-limiting example, location information included in the load characteristic information may be used to locate a particular container for removal such as in the case of air transport in which a passenger associated with a particular piece of luggage has not boarded a flight. As yet another non-limiting example, location information included in the load characteristic information may be used to identify, and potentially analyze, characteristics of particular freight to ensure that the freight is in compliance with applicable policies, regulations, or the like (e.g., regulations for the transport of hazardous materials).

In certain example embodiments, load characteristic information generated from sensor data received from the sensors 106 may be provided to an automated decision-making system 120 that may be configured to manage or control freight loading operations. For example, load characteristic information generated by the remote server 116 and/or the LCI presentation device 112 may be transmitted to the automated decision-making system 120. In certain other example embodiments, the automated decision-making system 120 may be configured to receive the sensor data and generate the load characteristic information itself. The automated decision-making system 120 may be configured to perform algorithmic processing based on the received load characteristic information and control or modify freight loading operations based on the results of such processing.

For example, based on the load characteristic information, the decision-making system 120 may generate an instruction indicative of a desired configuration or makeup for the load 104 and/or an instruction indicative of a desired in which packages or containers included in the load 104 are to be loaded into the vehicle 102, and may communicate the instruction to an end user or another automated system capable of implementing the instruction. As another non-limiting example, the automated decision-making system 120 may determine that a total weight threshold for the freight load 104 has been met or that a space utilization threshold has been met (e.g., 90% of the interior loading space of the vehicle 102 is occupied), and may transmit an instruction to another system (e.g., a conveyor belt system) to halt the loading of additional freight into the vehicle 102. In yet another non-limiting example, the automated decision-making system 120 may determine that the load 104 (which as described earlier may be an existing freight load or a planned load) fails to meet a space utilization threshold, a total weight threshold, a weight distribution threshold, a vibrational or movement-related threshold, or the like, and may instruct an end user or another system to modify the configuration or makeup of the load, or the manner in which the freight is loaded, in order to meet an applicable threshold.

Although various examples of types of sensors, types of sensor data, types of load characteristic information, and types of devices for generating, presenting, and acting upon the load characteristic information have been described above, it should be appreciated that such examples are merely illustrative and not exhaustive, and that numerous other alternatives, modifications, additions, and the like are within the scope of this disclosure. These and other aspects of the disclosure relating to generation, presentment, and use of load characteristic information will be described in more detail in reference to FIGS. 2-6.

FIG. 2 is a schematic block diagram of an illustrative system architecture 200 that, among other things, enables the receipt and processing of sensor data to generate load characteristic information in accordance with one or more example embodiments of the disclosure.

The illustrative architecture 200 may include one or more remote servers 202, one or more LCI presentation devices 204 operable by one or more users 206, one or more sensor nodes 210, and an automated decision-making system 270. In various example embodiments, the remote server(s) 202 may correspond to the remote server(s) 116. Further, the LCI presentation device(s) 204 may include the LCI presentation device 112 and the automated decision-making system 270 may correspond to the automated decision-making system 120. In addition, in certain example embodiments, the sensor node(s) 214 may correspond to a particular implementation of the broadcast node 110. While various illustrative components of the system architecture 200 may be described herein in the singular, it should be appreciated that multiple ones of any such components may be provided in various example embodiments of the disclosure.

The sensor node 210 is illustratively depicted in FIG. 2 as receiving sensor data from one or more sensors 208 associated with a vehicle. However, as noted earlier, embodiments of the disclosure are equally applicable to non-transport contexts, and as such, the sensor data 208 may be received from sensors that monitor characteristics of a non-mobile environment that may be used to house items. The sensor(s) may include any of the types of sensors previously described. The sensor node 210 may form part of a wireless sensor network (e.g., a wireless mesh network) that may also include the sensor(s). Multiple sensor nodes 210 may be provided with each sensor node 210 being communicatively coupled to one or more sensors.

Each sensor node 210 may include a transceiver 212 with an internal antenna 214, a microcontroller 216, sensor interface circuitry 218 for interfacing with the sensor(s), and a power source (e.g., a battery) for supplying power to the sensor node 210. In certain example embodiments, the antenna 214 may be provided externally to the sensor node 210, and the transceiver 212 may be provided with a connection to the external antenna. The sensor node 210 may be provided externally and independently from a vehicle such as at a loading dock or may be provided in or otherwise associated with a particular vehicle.

The sensor node 210 may be communicatively coupled to the LCI presentation device 204 via one or more networks 222. The network(s) 222 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the network(s) 222 may have any suitable communication range associated therewith and may include, for example, global networks (e.g., the Internet), metropolitan area networks (MANs), wide area networks (WANs), local area networks (LANs), or personal area networks (PANs). In addition, the network(s) 222 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof. In certain example embodiments, the sensor node 210 may also be communicatively coupled to the automated decision-making system 270 via one or more network(s) 222.

The sensor node 210 may be configured to communicate the sensor data 208 to the LCI presentation device 204 via one or more of the network(s) 222. In certain example embodiments, at least a portion of the components or the functionality of the sensor node 210 may be provided as part of a sensor instead. In such embodiments, the sensor may be capable of directly communicating the sensor data 208 to the LCI presentation device 204 or may communicate the sensor data 208 via a broadcast node capable of routing the sensor data 208 to the LCI presentation device 204, but not necessarily including all of the components and associated functionality of the illustrative sensor node 210 depicted in FIG. 2. It should also be appreciated that the sensor node 210 may communicate the sensor data 208 to the automated decision-making system 270 via one or more network(s) 222, and in certain example embodiments, the system 270 may be configured to generate load characteristic information based on the sensor data 208.

The LCI presentation device 204 may be a user device such as laptop computing device, a desktop computing device, a tablet computing device, a smartphone with data capabilities, a wearable computing device, or the like. Although the LCI presentation device 204 is depicted as being provided independently of the vehicle 102, as previously described, in certain example embodiments, the LCI presentation device 204 may be an in-vehicle device, potentially integrated with an existing in-vehicle infotainment (IVI) system or the like.

In certain example embodiments, the sensor node 210 and/or the LCI presentation device 204 may be configured to transmit the sensor data 208 to the remote server 202 via one or more wireless communication links that may form part of the network(s) 224. The network(s) 224 may include any of the types of networks described in connection with the network(s) 222, and in various example embodiments, the network(s) 224 and the network(s) 224 may include one or more same networks or network communication links. Further, although not depicted in FIG. 2, the automated decision-making system 270 may be communicatively coupled to the remote server 202, the sensor node 210, and/or the LCI presentation device 204 via one or more of the network(s) 224 in addition to, or in lieu of, a coupling via one or more of the network(s) 222. Accordingly, in certain example embodiments, the automated decision-making system 270 may be configured to receive load characteristic information generated by the remote server 202 and/or the LCI presentation device 204 via the network(s) 224.

In certain example embodiments, the remote server 202 may be configured to receive and process the sensor data 208 to generate load characteristic information 252. The remote server 202 may include any suitable computing device including, but not limited to, a server computer, a mainframe computer, a workstation, a desktop computer, a laptop computer, and so forth. In an illustrative configuration, the remote server 202 may include one or more processors (processor(s)) 226, one or more memory devices 228 (generically referred to herein as memory 228), additional data storage 230, one or more input/output (“I/O”) interface(s) 232, and/or one or more network interface(s) 234. These various components will be described in more detail hereinafter.

The memory 228 of the remote server 202 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 228 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 228 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The memory 228 may store computer-executable instructions that are loadable and executable by the processor(s) 226, as well as data manipulated and/or generated by the processor(s) 226 during the execution of the computer-executable instructions. For example, the memory 228 may store one or more operating systems (O/S) 236; one or more database management systems (DBMS) 238; one or more program modules, applications, or the like such as, for example, one or more load characteristic information determination modules 240, one or more recommendations modules 242, and so forth.

The load characteristic information determination module(s) 240 may include computer-executable instructions that responsive to execution by one or more of the processor(s) 226 may cause operations to be performed for generating load characteristic information 252 based on the sensor data 208. As previously noted, the load characteristic information 252 may include information indicative of characteristics of an existing, planned, or future load such as, for example, space utilization information that identifies occupied and available space along the height, length, or width of an interior of a vehicle or other interior space, weight distribution information, seismic information indicative of vibrational or motion characteristics of the freight load, and so forth. The sensor data 208 may be processed and analyzed in accordance with one or more algorithms in order to generate the load characteristic information 252. In certain example embodiments, additional types of data such as vehicle data 246, load data 248, route data 250, or the like may be processed and analyzed in conjunction with the sensor data 208 to generate the load characteristic information 252.

The vehicle data 246 may include various identifying information for one or more vehicles such as, for example, vehicle dimensions (e.g., interior loading space dimensions), vehicle weight, interior space characteristics (e.g., presence and location of shelving), or the like. As previously described, the load data 248 for any particular container may include, for example, a weight of the container, an identification of its contents, a time/datestamp indicative of when the container was loaded into a vehicle, dimensions of the container, or the like. At least a portion of the load data may be stored in, for example, a radio frequency identification (RFID) tag attached to or embedded in the container such that the load data may be read by an RFID reader. Alternatively, or additionally, the load data 248 may be captured by a device prior to placement of the load in a vehicle. The load data capturing device may be provided independent of the vehicle or may be integrated with or otherwise associated with a particular vehicle. As also previously described, the route data 250 may include any data that identifies one or more delivery parameters associated with one or more transportation routes such as, for example, origin and destination points, delivery schedules, and so forth. It should be appreciated that any of a variety of other types of data may additionally or alternatively be used to generate the load characteristic information 252 such as, for example, data indicative of applicable rules, regulations, protocols, etc. government the storage and/or transport of items.

In certain example embodiments, the load characteristic information determination module(s) 240 may include computer-executable instructions for processing and analyzing at least a portion of the load data 248 in conjunction with sensor data to generate load characteristic information that identifies a precise location of a particular container within the interior space of a vehicle. More specifically, the time/datestamp associated with the loading of a particular container of the load 104 into the vehicle 102 may be correlated with a change in the data sensed by a particular sensor (e.g., a time-of-flight sensor), and thus, a precise location of the container within the vehicle 102 may be determined. As previously described, such information may be used to generate a pricing structure for the transport of items, to identify particular items for removal such as in the context of a passenger who fails to board a flight, to ensure that applicable regulations are being met, and so forth.

The recommendations module(s) 242 may include computer-executable instructions that responsive to execution by one or more of the processor(s) 226 may cause operations to be performed for generating various recommendations to be presented along with the load characteristic information 252 to a user or the automated decision-making system 270. For example, recommendations for alternative load configurations or makeups may be generated based on the load characteristic information 252. Further, in certain example embodiments, the recommendations module(s) 242 may process and analyze at least a portion of the route data 250 in conjunction with the sensor data 208 in order to generate any of a variety of types of recommendations such as, for example, recommendations to alter delivery routes to reduce vibration or movement of a load during transport, recommendations to shift load between vehicles in a fleet in order to make more effective use of unoccupied space, recommendations to alter or limit the characteristics (e.g., density, size, etc.) of additional load, recommendations for a particular configuration or makeup of a planned load, or the like. In addition, the recommendations module(s) 242 may be configured to monitor a loading operation by analyzing sensor data received in real-time or near real-time and generate a notification when a particular load characteristic (e.g., space utilization, weight distribution, etc.) lies outside of a desired or threshold range.

In addition, as previously noted, at least a portion of the load data 248 may be assessed in conjunction with sensor data to generate load characteristic information that identifies a precise location of a particular container within the interior space of a vehicle. The recommendations module(s) 242 may include computer-executable instructions for analyzing such information to generate recommendations to move the container to a new location or place the container in a location different from a planned location within the vehicle in order to improve space utilization, reduce vibration or movement during transport, diminish the likelihood of damage to the contents of the container, or the like.

As previously noted, the various illustrative program modules depicted as being loaded into the memory 228 may include computer-executable instructions that in response to execution by the processor(s) 226 cause various processing to be performed. In order to perform such processing, the program modules may utilize various data/information stored in the memory 228, in the data storage 230, and/or in one or more external datastores 244. Further, while not depicted in FIG. 2, any of the data stored in external datastore(s) 244 or in the data storage 230 may be loaded into the memory 228 as well.

Referring now to other illustrative components of the remote server 202, the O/S 236 loaded into the memory 228 may provide an interface between other application software executing on the remote server 202 and the hardware resources of the remote server 202. More specifically, the O/S 236 may include a set of computer-executable instructions for managing the hardware resources of the remote server 202 and for providing common services to other application programs (e.g., managing memory allocation among various application programs). The O/S 236 may include any operating system now known or which may be developed in the future including, but not limited to, any server operating system, any mainframe operating system, or any other proprietary or non-proprietary operating system.

As previously noted, the remote server 202 may further include data storage 230 such as removable storage and/or non-removable storage including, but not limited to, magnetic storage, optical disk storage, and/or tape storage. The data storage 230 may provide non-transient storage of computer-executable instructions and other data. The data storage 230 may include storage that is internal and/or external to the remote server 202. The memory 228 and/or the data storage 230, removable and/or non-removable, are examples of computer-readable storage media (CRSM) as that term is used herein.

The DBMS 238 depicted as being loaded into the memory 228 may support functionality for accessing, retrieving, storing, and/or manipulating data stored in the external datastore(s) 244, data stored in the memory 228, and/or data stored in the data storage 230. The DBMS 238 may use any of a variety of database models (e.g., relational model, object model, etc.) and may support any of a variety of query languages. It should be appreciated that any data and/or computer-executable instructions stored in the memory 236, including any of the program modules, the O/S 236, and the DBMS 238, may be additionally, or alternatively, stored in the data storage 230 and/or in one or more of the external datastore(s) 244 and loaded into the memory 228 therefrom. The datastore(s) 244 may include any suitable data repository including, but not limited to, databases (e.g., relational, object-oriented, etc.), file systems, flat files, distributed datastores in which data is stored on more than one node of a computer network, peer-to-peer network datastores, or the like. Any of the datastore(s) 244 may represent data in one or more data schemas. The datastore(s) 244 are illustratively depicted in FIG. 2 as storing the vehicle data 246, the load data 248, the route data 250, and the load characteristic information 252. Although not depicted in FIG. 2, the datastore(s) 244 may also store the sensor data 208 or any other suitable type of data.

The processor(s) 226 may be configured to access the memory 228 and execute computer-executable instructions stored therein. For example, the processor(s) 226 may be configured to execute computer-executable instructions of the various program modules of the remote server 202 to cause or facilitate various operations to be performed in accordance with one or more embodiments of the disclosure. The processor(s) 226 may include any suitable processing unit capable of accepting digital data as input, processing the input data in accordance with stored computer-executable instructions, and generating output data. The processor(s) 226 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

The remote server 202 may further include one or more I/O interfaces 232 that may facilitate the receipt of input information by the remote server 202 from one or more I/O devices as well as the output of information from the remote server 202 to the one or more I/O devices. The I/O devices may include, for example, one or more user interface devices that facilitate interaction between a user and the remote server 202 including, but not limited to, a display, a keypad, a pointing device, a control panel, a touch screen display, a remote control device, a microphone, a speaker, and so forth. The I/O devices may further include, for example, any number of peripheral devices such as data storage devices, printing devices, and so forth.

The remote server 202 may be configured to communicate with any of a variety of other systems, platforms, networks, devices, and so forth (e.g., the sensor node 210, the LCI presentation device 204, the automated decision-making system 270, etc.) via one or more of the network(s) 224. The remote server 202 may include one or more network interfaces 234 that may facilitate communication between the remote server 202 and any of the systems, networks, platforms, devices or components of the system architecture 200.

In certain example embodiments, the remote server 202 may be configured to transmit the load characteristic information 252 as well as any recommendations that have been generated to the LCI presentation device 204. In an illustrative configuration, the LCI presentation device 204 may include one or more processors (processor(s)) 254, one or more memory devices 256 (generically referred to herein as memory 256), additional data storage 258, one or more input/output (“I/O”) interface(s) 260, and/or one or more network interface(s) 262. These various components will be described in more detail hereinafter.

The memory 256 of the LCI presentation device 204 may include any of the types of memory described in reference to the memory 228 of the remote server 202. The memory 256 may store computer-executable instructions that are loadable and executable by the processor(s) 254, as well as data manipulated and/or generated by the processor(s) 254 during the execution of the computer-executable instructions. For example, the memory 256 may store one or more operating systems (O/S) 264; and one or more program modules, applications, or the like such as, for example, a user interface 266 (e.g., a GUI), one or more software modules 268, and so forth. Although not depicted in FIG. 2, the LCI presentation device 204 may further include a DBMS with similar functionality as described in connection with DBMS 238 of the remote server 202.

The software module(s) 268 may include computer-executable instructions that when executed by one or more of the processor(s) 254 direct the GUI 266 to present load characteristic information to a user via a display (not depicted) of the LCI presentation device 204. The load characteristic information may be presented in any suitable format including, but not limited to, text, audio, video, or graphical format. As described earlier, a graphical representation of the interior of a vehicle that depicts organized configuration or makeup of an existing or planned load may be generated from the load characteristic information and presented to a user.

Based on a review of the load characteristic information, a user 206 may choose to alter one or more characteristics of an existing load or a planned load. For example, a user 206 may choose to alter a configuration, makeup, or other properties of an existing or planned load to make more effective use of under-utilized space, to reduce vibration or movement of the load during transport, to alter a weight distribution of the load to provide more protection for the contents of the load, and so forth. It should be appreciated that in various example embodiments such decisions may be made in an automated manner by the automated decision-making system 270. In addition, in certain example embodiments, the LCI presentation device 204 and/or the automated decision-making system 270 may be configured to receive (and in the case of the LCI presentation device 204, present to a user 206) load characteristic information associated with multiple existing or planned loads, thereby allowing determinations to be made as to what actions may need to be taken to improve load characteristics across loads associated with multiple vehicles.

In certain example embodiments, the load characteristic information may be based at least in part on sensor data gathered during transport of a load, and may be analyzed by the user 206 to determine how the configuration of future loads can be improved to more effectively utilize interior space, reduce vibration and movement of the load during transport or modify weight distribution to better secure a load or lessen the likelihood of damage to load contents, and so forth. In addition, the load characteristic information may relate to a fleet of vehicles, allowing the user 206 to identify whether an existing load can be shifted between vehicles in the fleet or whether the configuration or makeup of one or more planned loads for a fleet can be modified to improve load characteristics. A dynamic representation of the load configuration over time (e.g., during transit, during loading, etc.) may also be presented to the user 206 via the LCI presentation device 204 (or to the automated decision-making system 270). This dynamic representation may allow the user to determine how a configuration or makeup of a load, vibrational or movement characteristics of the load, a weight distribution of the load, or the like may have changed over time.

In certain example embodiments, a capability to manipulate a representation of the load characteristic information may be provided to the user 206 such that the user 206 may experiment with various hypothetical load configurations prior to modifying actual load configurations. The functionality for allowing manipulation of the load characteristic information may be transmitted to the LCI presentation device 204 by the remote server 202 in the form of computer-executable code executable by one or more of the processor(s) 254 or may be generated by the LCI presentation device 204 such as, for example, by one or more of the software module(s) 268.

More specifically, in various example embodiments, LCI presentation device 204 may be configured to receive input from a user 206 via one or more of the input/output interfaces 260. The input may be processed by one or more of the software module(s) 268 to generate and present, via the GUI 266, modified representations of the load characteristic information. For example, the user 206 may be provided with a capability to move load to different hypothetical locations within a three-dimensional representation of the interior of a vehicle. Information that indicates the effect on space utilization, vibrational or movement characteristics, weight distribution, or the like of the hypothetical modifications to the load configuration may be presented to the user 206. Further, the user 206 may also be provided with a capability to view, in graphical form, an effect of modifying a load configuration in accordance with a recommendation that has been provided.

In addition to, or in lieu of, presentment of the load characteristic information 252 to an end user 206 via the LCI presentation device 204, the automated decision-making system 270 may receive (or generate) the load characteristic information 252 and may be configured to control freight loading operations to ensure that one or more load characteristics are achieved such as, for example, by modifying one or more aspects of an existing or planned load. Moreover, the automated decision-making system 270 may be configured to request (or generate) and analyze hypothetical load configurations based on the load characteristic information 252.

Although the load characteristic information 252 has been described as being generated by the remote server 202, it should be appreciated that the LCI presentation device 204 may additionally, or alternatively, be configured to receive the sensor data 208 from the sensor node 210, and one or more of the software module(s) 268 may include computer-executable instructions for processing and analyzing the sensor data 208 to generate the load characteristic information 252. In certain example embodiments, the processing to generate the load characteristic information 252 may be distributed between the remote server 202 and the LCI presentation device 204. In addition, in certain example embodiments, the automated decision-making system 270 may be configured to generate the load characteristic information 252 based on received sensor data 208.

Referring again to the illustrative components of the LCI presentation device 204, the various illustrative program modules depicted as being loaded into the memory 256 may include computer-executable instructions that in response to execution by the processor(s) 254 cause various processing to be performed. In order to perform such processing, the program modules may utilize various data/information stored in the memory 256, in the data storage 258, and/or in one or more external datastores (not shown). The data storage 258 may include any of the types of data storage described in reference to the data storage 230. Further, while not depicted in FIG. 2, any data stored in external datastore(s) or in the data storage 258 may be loaded into the memory 256 as well.

Referring now to other illustrative components of the LCI presentation device 204, the O/S 264 loaded into the memory 256 may provide an interface between other application software executing on the LCI presentation device 204 and the hardware resources of LCI presentation device 204. More specifically, the O/S 264 may include a set of computer-executable instructions for managing the hardware resources of the LCI presentation device 204 and for providing common services to other application programs (e.g., managing memory allocation among various application programs). The O/S 264 may include any operating system described in reference to the O/S 236 of the remote server 202.

The processor(s) 254 may be configured to access the memory 256 and execute computer-executable instructions stored therein. For example, the processor(s) 254 may be configured to execute computer-executable instructions of the various program modules of the LCI presentation device 204 to cause or facilitate various operations to be performed in accordance with one or more embodiments of the disclosure. The processor(s) 254 may include any suitable processing unit capable of accepting digital data as input, processing the input data in accordance with stored computer-executable instructions, and generating output data. The processor(s) 254 may include any of the types of processing units described in reference to the processor(s) 226.

The LCI presentation device 204 may further include one or more I/O interfaces 260 that may facilitate the receipt of input information by the LCI presentation device 204 from one or more I/O devices as well as the output of information from the LCI presentation device 204 to the one or more I/O devices. The I/O devices may include, for example, one or more user interface devices that facilitate interaction between a user and the LCI presentation device 204 including, but not limited to, a display, a keypad, a pointing device, a control panel, a touch screen display, a remote control device, a microphone, a speaker, and so forth. The I/O devices may further include, for example, any number of peripheral devices such as data storage devices, printing devices, and so forth.

The LCI presentation device 204 may be configured to communicate with any of a variety of other systems, platforms, networks, devices, and so forth (e.g., the sensor node 210, the remote server 202, the automated decision-making system 270, etc.) via one or more of the network(s) 224 or one or more of the network(s) 222. The LCI presentation device 204 may include one or more network interfaces 262 that may facilitate communication between the LCI presentation device 204 and any of the systems, networks, platforms, devices or components of the system architecture 200.

It should be appreciated that the program modules depicted in FIG. 2 as being loaded into the memory 228 or the memory 256 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted on the remote server 202, hosted on the LCI presentation device 204, hosted on one or more components of the automated decision-making system, and/or hosted on another network-accessible device may be provided to support functionality provided by the program modules depicted in FIG. 2 and/or additional or alternate functionality. Further, functionality may be modularized differently such that processing described as being supported collectively by a collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices of the system architecture 200 in accordance with any suitable computing model such as, for example, a client-server model, a peer-to-peer model, and so forth.

It should be appreciated that the sensor node 210, the remote server 202, and the LCI presentation device 204 (or any other illustrative component of the system architecture 200) may include alternate and/or additional hardware, software, or firmware components beyond those described or depicted without departing from the scope of the disclosure. More particularly, it should be appreciated that software, firmware, or hardware components depicted as forming part of any of the devices of the architecture 200 are merely illustrative and that some components may not be present or additional components may be provided in various embodiments. While various illustrative program modules have been depicted as software modules loaded into a memory, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules.

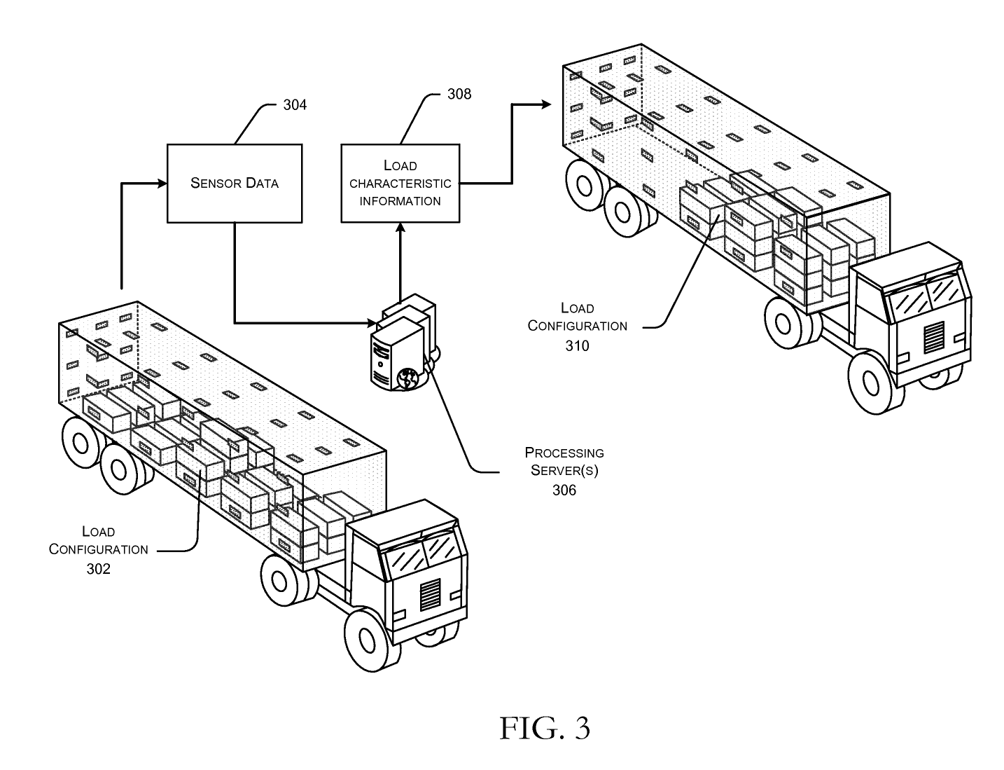

FIG. 3 is a data flow diagram that illustrates use of load characteristic information generated based on sensor data to alter one or more characteristics of a load in accordance with one or more embodiments of the disclosure. The load may be an existing load or a planned load.

As depicted in FIG. 3, a vehicle may be loaded with freight having a particular existing or planned load configuration 302. Sensor data 304 may be collected in accordance example embodiments of the disclosure described previously and transmitted to one or more processing servers 306. As described previously, the processing server(s) 306 may include one or more remote servers 202, one or more LCI presentation devices 204, and/or the automated decision-making system 270. The processing server(s) 306 may process the sensor data 304 in accordance with example embodiments of the disclosure described previously to generate load characteristic information 308. The load characteristic information 308 may then be presented to a user via, for example, an appropriate LCI presentation device 204 or to the automated decision-making system 270.

As previously described, the user (or the automated decision-making system 270) may review, analyze, manipulate, etc. the load characteristic information 308 to identify one or more modifications that can be made to the load configuration 302 in order to optimize space utilization, lessen vibration or movement of the load during transit, lessen the likelihood of damage to the load contents, and so forth. In certain example embodiments, the load characteristic information 308 may be used to identify a modified weight distribution that is less likely to generate vibration or movement of the load, and thus, more likely to prevent damage to the load contents. A new load configuration 310 may be identified based on the parameters sought to be optimized, and the load configuration 302 may be modified to generate the load configuration 310.

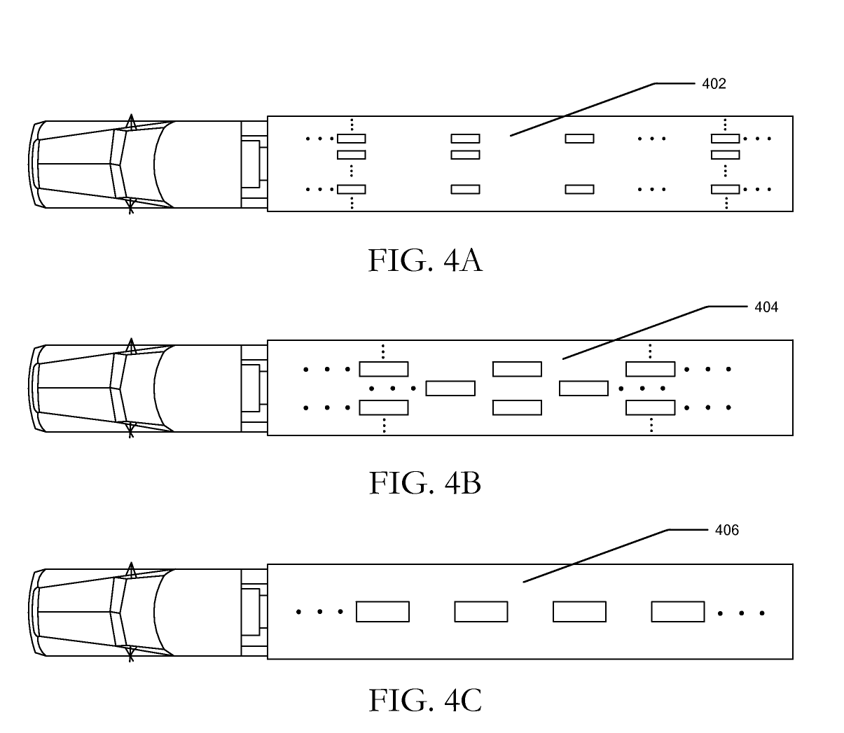

FIGS. 4A-4C are schematic diagrams illustrating various sensor arrangements in accordance with one or more example embodiments of the disclosure.

FIG. 4A depicts an illustrative sensor configuration 402 in which the sensors are arranged in an array or grid-like pattern. FIG. 4B depicts an illustrative configuration 404 in which the sensors are arranged in a staggered pattern. FIG. 4C depicts an illustrative configuration 406 in which the sensors are in a linear arrangement. It should be appreciated that the sensor arrangements depicted in FIGS. 4A-4C are merely illustrative and should not be deemed limiting in any way. For example, any alternative arrangement is possible including, but not limited to, a single sensor arrangement, a random distribution, and so forth. Further, while the sensors are illustratively depicted as being provided in or on an interior ceiling of a vehicle, it should be appreciated that the sensors may be provided at any suitable location as described previously.

### Illustrative Processes

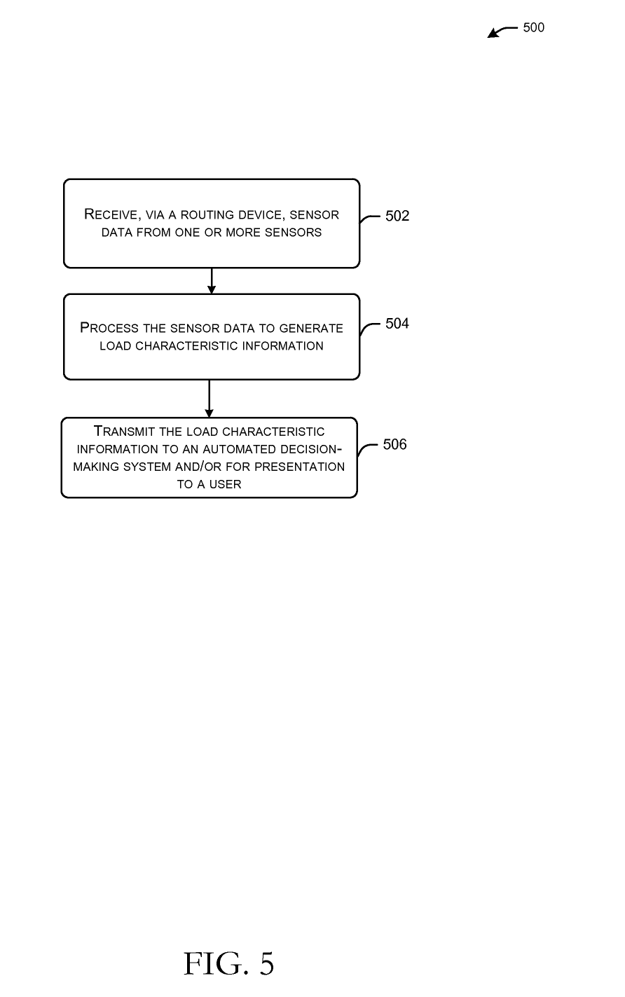

FIG. 5 is a process flow diagram of an illustrative method 500 for processing sensor data to generate load characteristic information in accordance with one or more example embodiments of the disclosure. One or more operations of the method 500 may be described as being performed by the remote server 202, or more specifically, by one or more program modules executing on the remote server 202. It should be appreciated, however, that any of the operations of the method 500 may be performed by another device or component of the system architecture 200 such as, for example, the LCI presentation device 204. In addition, it should be appreciated that processing performed in response to execution of computer-executable instructions provided as part of an application, program module, or the like may be described herein as being performed by the application or program module itself, by a device on which the application, program module, or the like is executing, or by a system that includes such a device. While the operations of the method 500 are described in the context of the illustrative system architecture 200, it should be appreciated that the method may be implemented in connection with numerous other architectural and device level configurations.

At block 502, a remote server 202 may receive, via a routing device, sensor data gathered by one or more sensors such as one or more vehicle sensors. The routing device may be a sensor node 210, an LCI presentation device 204, or the more generalized broadcast device 110 depicted in FIG. 1.

At block 504, computer-executable instructions provided as part of the load characteristic information determination module(s) 240 may be executed to generate load characteristic information based on the received sensor data. As previously described, the load characteristic information determination module(s) 240 may further utilize load data, route data, and/or vehicle data to generate the load characteristic information. In addition, the load characteristic information may further include recommendations generated responsive to execution of computer-executable instructions provided as part of the recommendations module(s) 242 for modifying a load configuration to optimize space utilization, minimize vibration or movement of the load, and so forth.

At block 506, the load characteristic information may be transmitted for presentation to a user. For example, the remote server 202 may transmit the load characteristic information to one or more LCI presentation devices 204 for presentation to a user. Additionally, or alternatively, the load characteristic information may be transmitted to an automated decision-making system.

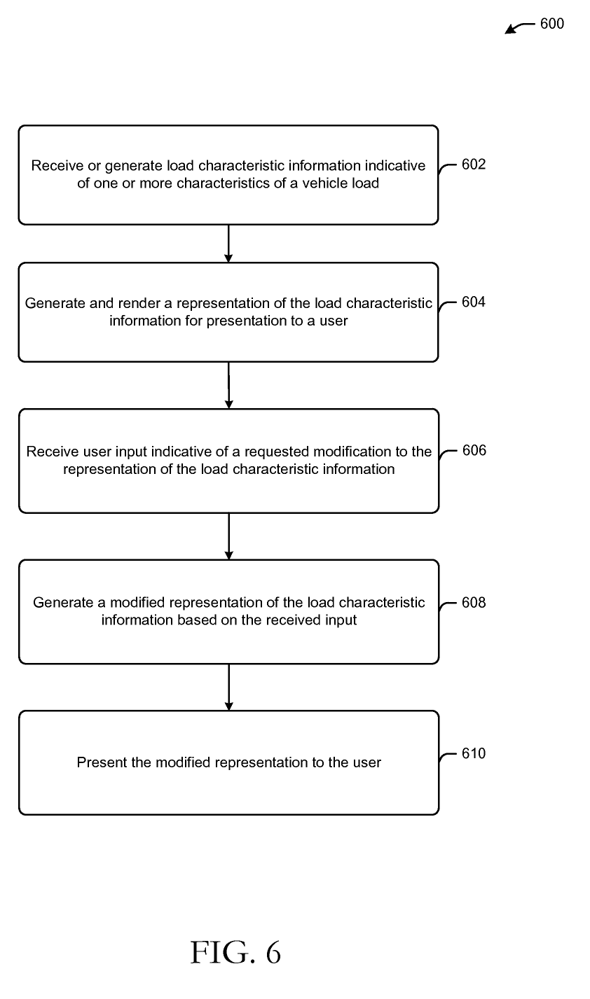

FIG. 6 is a process flow diagram of an illustrative method 600 for rendering a representation of load characteristic information and generating one or more modified representations of the load characteristic information based on user input in accordance with one or more embodiments of the disclosure. One or more operations of the method 600 may be described as being performed by an LCI presentation device 204, or more specifically, by one or more program modules executing on an LCI presentation device 204. It should be appreciated, however, that any of the operations of the method 600 may be performed by another device or component of the system architecture 200 such as, for example, the remote server 202. In addition, it should be appreciated that processing performed in response to execution of computer-executable instructions provided as part of an application, program module, or the like may be described herein as being performed by the application or program module itself, by a device on which the application, program module, or the like is executing, or by a system that includes such a device. While the operations of the method 600 are described in the context of the illustrative system architecture 200, it should be appreciated that the method may be implemented in connection with numerous other architectural and device level configurations.

At block 602, an LCI presentation device 204 may receive from a remote server 202, or generate itself, load characteristic information indicative of one or more characteristics of a vehicle load. As previously described, the load characteristic information may include space utilization information, weight distribution information (including potentially locations, weights, contents, friction characteristics, etc. of particular containers or packages included in the load), information indicative of vibrational or movement characteristics of the load, delivery route information for the load, and so forth. The load characteristic information may further include one or more recommendations for altering a configuration or makeup of the load along with information identifying the effects of such altered configurations on space utilization, weight distribution, vibration or movement characteristics, or the like.

At block 604, the LCI presentation device 204 may generate and render a representation of the load characteristic information for presentation to a user. The representation may be presented via a GUI or other user interface of the device and may take on any of the forms previously described.

At block 606, the LCI presentation device 204 may receive input from the user to modify the representation of the load characteristic information. For example, the user may be provided with a capability to move load to different hypothetical locations within a three-dimensional representation of the interior of a vehicle. The input may correspond to different hypothetical load locations that the user is requesting to be rendered. As another example, the user may request a modified representation that reflects the effects of a recommended modified load configuration.

At block 608, the LCI presentation device 204 may generate a modified representation of the load characteristic information based on the input received from the user, and at block 610, the LCI presentation may present the modified representation to the user.

It should be appreciated that the operations of blocks 606-610 may be performed iteratively any number of times depending on the amount of input received from the user. The user may then modify an existing load configuration, a planned load configuration (e.g., an in-progress load), or a future load configuration based on an analysis of the various modified representations of the load characteristic information.

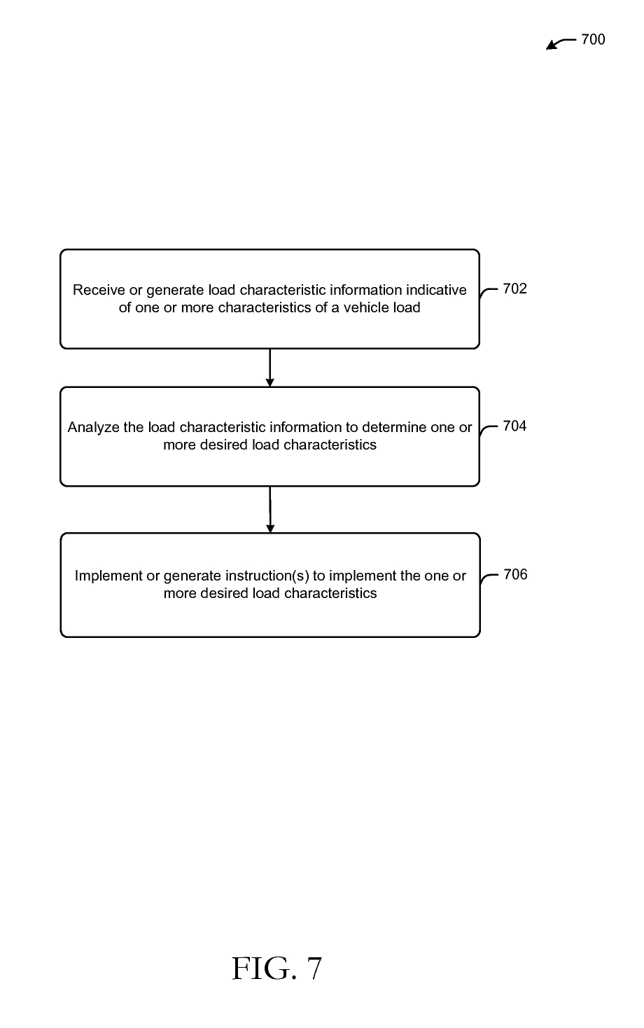

FIG. 7 is a process flow diagram of an illustrative method 700 for executing automated decision-making processing to cause one or more desired load characteristics to be achieved in accordance with one or more embodiments of the disclosure. One or more operations of the method 700 may be described as being performed by an automated decision-making system 270, or more specifically, by one or more program modules executing on such a system. It should be appreciated, however, that any of the operations of the method 700 may be performed by another device or component of the system architecture 200 such as, for example, the remote server 202. In addition, it should be appreciated that processing performed in response to execution of computer-executable instructions provided as part of an application, program module, or the like may be described herein as being performed by the application or program module itself, by a device on which the application, program module, or the like is executing, or by a system that includes such a device. While the operations of the method 700 are described in the context of the illustrative system architecture 200, it should be appreciated that the method may be implemented in connection with numerous other architectural and device level configurations.

At block 702, the automated decision-making system 270 may receive from a remote server 202, or generate itself, load characteristic information indicative of one or more characteristics of a vehicle load. As previously described, the load characteristic information may include space utilization information, weight distribution information, information indicative of vibrational or movement characteristics of the load, delivery route information for the load, and so forth. The load characteristic information may further include one or more recommendations for altering a configuration or makeup of the load along with information identifying the effects of such altered configurations on space utilization, weight distribution, vibration or movement characteristics, or the like.

At block 704, the automated decision-making system 270 may analyze the load characteristic information in accordance with one or more decision algorithms in order to determine one or more desired characteristics for an existing or planned load. For example, the automated decision-making system 270 may analyze the load characteristic information to assess a space utilization characteristic, a vibration or movement characteristic, a weight distribution characteristic, or the like associated with an existing or planned load and determine a desired characteristic based on the assessment.

At block 706, the automated decision-making system 270 may implement or generate one or more instructions to implement the desired load characteristic(s). For example, the automated decision-making system 270 may instruct an operator or another system to modify a configuration or makeup of an existing or planned load, to halt the loading of additional freight, to modify the manner in which items are loaded into a particular environment, and so forth.

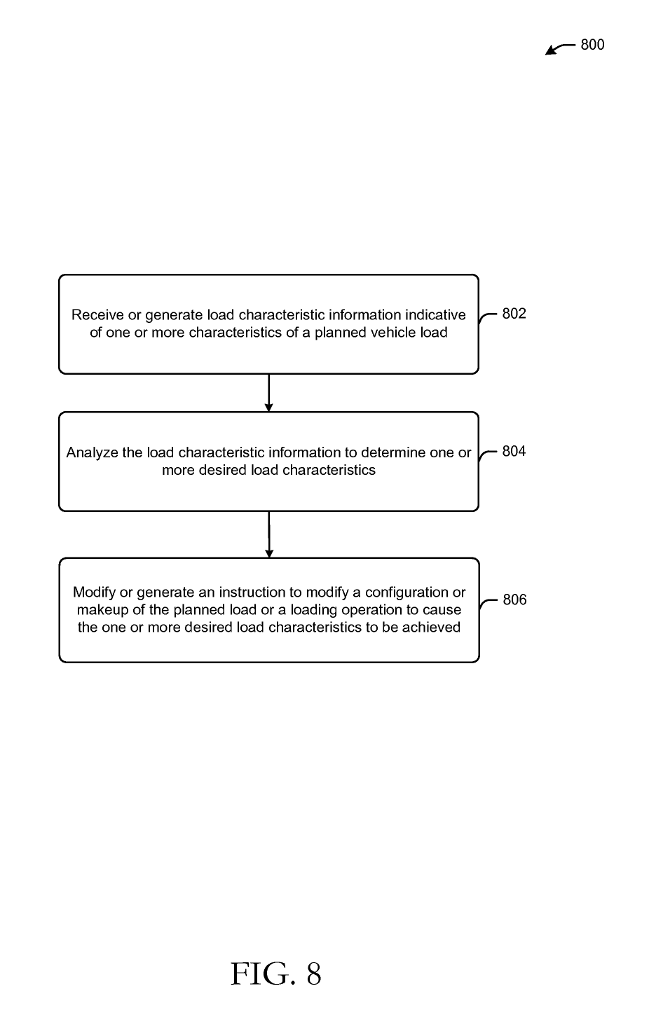

FIG. 8 is a process flow diagram of an illustrative method 800 for modifying one or more characteristics of a planned load based on load characteristic information generated from sensor data in accordance with one or more embodiments of the disclosure. One or more operations of the method 800 may be performed by the automated decision-making system 270, the LCI presentation device 204, a manual operator, or by another device or component of the system architecture 200 such as, for example, the remote server 202. In addition, it should be appreciated that processing performed in response to execution of computer-executable instructions provided as part of an application, program module, or the like may be described herein as being performed by the application or program module itself, by a device on which the application, program module, or the like is executing, or by a system that includes such a device. While the operations of the method 800 are described in the context of the illustrative system architecture 200, it should be appreciated that the method may be implemented in connection with numerous other architectural and device level configurations.

At block 802, the automated decision-making system 270 or the LCI presentation device 204 may receive from a remote server 202, or generate itself, load characteristic information indicative of one or more characteristics of a planned vehicle load. The planned vehicle load may include one or more existing loads (e.g., freight that has already been loaded into one or more vehicles) and/or additional freight planned on being loaded but which has not yet been loaded. Accordingly, a planned load may refer to a one or more vehicle loads that are in-progress.

At block 804, the automated decision-making system 270 may analyze the load characteristic information in accordance with one or more decision algorithms in order to determine one or more desired characteristics for the planned load. Alternatively, or additionally, a user such as a manual load operator may analyze the load characteristic information to identify the desired load characteristic(s). As a non-limiting example, load characteristic information associated with two vehicles that are being loaded simultaneously may be analyzed to determine which vehicle should receive additional freight in order to achieve a desired space utilization characteristic, weight distribution characteristic, vibration or movement characteristic, or the like. As another non-limiting example, the load characteristic information may be analyzed to identify when a vehicle has reached a threshold space utilization or freight weight, and thus, whether the vehicle is capable of accepting additional freight. As part of the analysis performed at block 804, various simulations may be run to determine the effect on various load characteristics of hypothetical modifications to the configuration or makeup of the planned load or a loading operation associated with the planned load.

At block 806, the automated decision-making system 270 and/or the user may modify or generate an instruction to modify a configuration or makeup of the planned load or a loading operation associated with the planned load in order to cause the one or more desired characteristics to be achieved. For example, the configuration or makeup of freight that has already been loaded or additional freight planned for loading may be adjusted to achieve the desired load characteristic(s). As a non-limiting example, packages may be ceased to be delivered to a conveyor belt when a desired space utilization, weight distribution, total weight, or the like is achieved.

The operations described and depicted in the illustrative methods of FIGS. 5-8 may be carried out or performed in any suitable order as desired in various embodiments of the disclosure. Additionally, in certain embodiments, at least a portion of the operations may be carried out in parallel. Furthermore, in certain embodiments, less, more, or different operations than those depicted in FIGS. 5-8 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. As an illustrative example, while example embodiments of the disclosure have been described in the context of freight that is loaded into a particular environment, it should be appreciated that such embodiments are also applicable to contexts in which freight is unloaded from an environment such as a vehicle. That is, load characteristic information may be utilized to identify desired load characteristics in connection with the unloading of freight such as, for example, a most efficient order for unloading freight, the manner in which contents may be removed from packages (which may be determined from an assessment of the nature of the contents), and so forth.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program modules, applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers), data storage (e.g., file management) routines, other common routines and services, etc.), or third-party software components (e.g., middleware, encryption or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

1. One or more non-transitory computer-readable media storing computer-executable instructions that, responsive to execution by one or more computer processors, cause operations to be performed comprising:
identifying sensor data received via a network interface and generated by one or more sensors attached to a vehicle, wherein the sensor data is indicative of one or more sensed parameters including a vibrational parameter for a first vehicle load;
identifying transport data received via the network interface, wherein the transport data comprises at least one or more delivery parameters associated with a transportation route for the first vehicle load;
generating, using at least the sensor data and the transport data, load characteristic information for a second vehicle load, wherein the load characteristic information comprises a vibrational characteristic for at least one item of the second vehicle load, the vibrational characteristic indicative of how the at least one item responds to vibrational forces; and
determining, using at least the load characteristic information, a load position of the at least one item within the vehicle for transport over the transportation route.

2. The one or more computer-readable media of claim 1, further comprising:
transmitting the load characteristic information to a device configured to render the load characteristic information for presentation to a user or analyze the load characteristic information to identify one or more desired characteristics for the second vehicle load, wherein the network interface is a first network interface, and wherein transmitting the load characteristic information comprises transmitting the load characteristic via a second network interface to the device configured to render the load characteristic information.

3. The one or more computer-readable media of claim 1, further comprising:
generating one or more recommendations for modifying the load position of the at least one item during the transport by the vehicle.

4. The one or more computer-readable media of claim 3, wherein generating the one or more recommendations comprises generating, using at least the vibrational characteristic, a first recommendation comprising at least one of a second transportation route, a reconfiguration of the second vehicle load, or driving characteristics.

5. The one or more computer-readable media of claim 1, the operations further comprising:
retrieving seismic sensor data,
wherein the load characteristic information is generated further using at least the seismic sensor data.

6. A method, comprising:
identifying, by a computerized system comprising one or more computer processors, sensor data received via a network interface and generated by one or more sensors, wherein the sensor data is indicative of one or more sensed parameters for a first load;
identifying, by the computerized system, transport data received via the network interface, wherein the transport data comprises at least one or more delivery parameters associated with a transportation route for the first load;
generating, by the computerized system using at least the sensor data and the transport data, load characteristic information for a second load, wherein the load characteristic information is indicative of one or more characteristics of items located in or designated for placement in an interior structure, and wherein the one or more characteristics comprise a space utilization characteristic and a vibrational characteristic for at least a first item of the items, the vibrational characteristic indicative of how the first item responds to vibrational forces; and
determining, by the computerized system using at least the load characteristic information, a load position of the first item within the interior structure for transport over the transportation route.

7. The method of claim 6, wherein the second load comprises at least one of: i) freight that has been loaded in an interior space of a vehicle or ii) additional freight that has been planned for loading in the interior space of the vehicle.

8. The method of claim 7, wherein the space utilization characteristic comprises at least one of: an amount of the interior space that is unoccupied by any portion of the second load or one or more locations within the interior space that are unoccupied by any portion of the second load.

9. The method of claim 7, wherein the one or more characteristics further comprise at least one of: a movement characteristic of the second load, or a weight distribution characteristic of the second load.

10. The method of claim 7, further comprising
generating, using at least the vibrational characteristic, one or more recommendations for modifying a configuration or makeup of the second load.

11. The method of claim 10, wherein the sensor data includes seismic sensor data, and wherein generating the one or more recommendations comprises generating, using at least the seismic sensor data, a first recommendation comprising at least one of a route, a modification to the configuration of the second load, or driving characteristics.

12. The method of claim 7, further comprising:
retrieving, by the computerized system, seismic sensor data for at least one of a route or a first item of the items,
wherein the load characteristic information is generated further using at least the seismic sensor data.

13. The method of claim 12, wherein the load characteristic information is generated further using at least load data, and wherein the load data comprises a respective weight of each of one or more items of the second load.

14. The method of claim 13, further comprising:
determining, using at least the load data and the seismic sensor data, a respective location of each of the items of the second load,
wherein the load characteristic information further comprises an indication of each respective location.

15. The method of claim 12, wherein the load characteristic information further comprises load characteristic information associated with one or more additional vehicle loads.

16. The method of claim 7, further comprising:
generating a pricing structure for fragile items of the second load using at least the vibrational characteristic.

17. (canceled)

18. A system, comprising:
at least one network interface;
at least one memory storing computer-executable instructions; and
at least one processor communicatively coupled to the at least one network interface and the at least one memory and configured to access the at least one memory and to execute the computer-executable instructions to:
identify sensor data generated by one or more sensors, wherein the sensor data is indicative of one or more sensed parameters for a first vehicle load;
identify transport data comprising at least one or more delivery parameters associated with a transportation route for the first vehicle load;
generate, using at least the sensor data and the transport data, load characteristic information for a second vehicle load, wherein the load characteristic information is indicative of a space utilization characteristic of the second vehicle load and a vibrational characteristic for at least one item in the second vehicle load, the vibrational characteristic being indicative of how the at least one item responds to vibrational forces; and
perform at least one of:
i) generate and render a representation of the load characteristic information for presentation to a user,
ii) transmit the load characteristic information for presentation to the user, or
iii) transmit the load characteristic information to an automated decision-making system configured to identify one or more desired characteristics for the second vehicle load using at least the load characteristic information, and
iv) determine, using at least the identification of at least one desired characteristic for the at least one item, a load position of the at least one item within the vehicle for transport over the transportation route.

19. The system of claim 18, wherein the sensor data comprises seismic data.

20. A device, comprising:
at least one network interface;
a display;
at least one memory storing computer-executable instructions; and
at least one processor communicatively coupled to the at least one network interface, the at least one memory, and the display, wherein the at least one processor is configured to access the at least one memory and to execute the computer-executable instructions to:
identify transport data comprising at least one or more delivery parameters associated with a transportation route for a first vehicle load;
generate a representation of load characteristic information indicative of one or more characteristics of a second vehicle load, the characteristics including vibrational characteristics indicative of how at least a portion of respective items in the second vehicle load respond to vibrational forces, wherein the load characteristic information is generated using at least sensor data generated by one or more sensors associated with a vehicle with which the second vehicle load is associated and the transport data; and
determine, using at least the load characteristic information, a load position of the respective items within the vehicle for transport over the transportation route.

21. The device of claim 20, wherein the device further comprises one or more input interfaces, and wherein the at least one processor is further configured to execute the computer-executable instructions to:
identify user input received via at least one of the one or more input interfaces;
generate a modified representation of the load characteristic information using at least the user input; and
direct presentation of the modified representation of the load characteristic information via the display, and
wherein, the determination of the load position of the respective items in the vehicle is further based upon the modified representation of the load characteristic information.

22. The device of claim 21, wherein the user input comprises a selection of a recommended modification to a configuration of the second vehicle load included in the load characteristic information.

23. The device of claim 20, wherein the at least one processor is further configured to execute the computer-executable instructions to:
identify the sensor data responsive to receipt of the sensor data via the at least one network interface; and
generate the load characteristic information using at least the sensor data.

24. An automated decision-making system, comprising:
at least one network interface;
at least one memory storing computer-executable instructions; and
at least one processor communicatively coupled to the at least one network interface and the at least one memory, wherein the at least one processor is configured to access the at least one memory and to execute the computer-executable instructions to:
receive transport data comprising one or more delivery parameters associated with a transportation route for a first vehicle load;
receive load characteristic information indicative of one or more characteristics of a second vehicle load, the one or more characteristics comprising a vibrational characteristic indicative of how an item in the second vehicle load responds to vibrational forces, wherein the load characteristic information is generated using at least sensor data generated by one or more sensors associated with a vehicle with which the second vehicle load is associated and the transport data; and
determine, using at least the load characteristic information, a load position of the item within the vehicle for transport over the transportation route.

25. (canceled)

26. The system of claim 24, wherein the at least one processor is further configured to execute the computer-executable instructions to communicate one or more instructions to an operational system or a manual operator.

27. The system of claim 24, wherein the at least one processor is configured to analyze the load characteristic information to identify one or more desired characteristics using at least one or more load characteristic thresholds.

28. The method of claim 10, wherein generating the one or more recommendations comprises generating a dynamic representation of changes to the configuration or makeup of the second load.

29. The system of claim 24, wherein the one or more instructions comprise at least one of a route determined using at least the vibrational characteristic, a modification to the configuration of the second vehicle load determined using at least the vibrational characteristic, or driving characteristics determined using at least the vibrational characteristic.

30. The one or more computer-readable media of claim 1, wherein the sensor data is first sensor data and the transport data is first transport data, the operations further comprising:
determining second sensor data indicative of sensed parameters for the second vehicle load during transport along the transportation route;
determining second transport data using at least the first sensor data and the second sensor data for use during subsequent transport along the transportation route.

31. The one or more computer-readable media of claim 1, wherein the at least one or more delivery parameters comprise first vibrational data for a first portion of the vehicle at a first portion of the transportation route and second vibrational data for a second portion of the vehicle at a second portion of the transportation route.
